(19) United States
(12) Patent Application Publication
(10) Pub. No.: US 2013/0099076 A1
(43) Pub. Date: Apr. 25, 2013

(54) MOUNTABLE HOOK FOR HANGING DECORATIVE LIGHT STRANDS

(71) Applicant: Lawrence Mickelson, West Liberty, KY (US)

(72) Inventor: Lawrence Mickelson, West Liberty, KY (US)

(21) Appl. No.: 13/280,480

(22) Filed: Oct. 25, 2011

(51) Int. Cl. F16B 45/02; F16B 2/20; H01F 7/02; F16B 45/00

(52) U.S. Cl. 248/206.5; 248/304; 248/231.81

(57) ABSTRACT

A mountable bracket for hanging strands of decorative lights through a cylindrical hook with flared ends which permit the unhindered movement of the light strands through the cylindrical hook. The bracket may be remotely attached and detached to a gutter along a roof through the use of an attachment device attached to a painter's pole which couples with the bracket.

### FIELD

This system relates to brackets used for stringing rope-like decorations along rooflines. More specifically, this system relates to brackets used for stringing strands of lights along roof-lines while standing on the ground and methods of using the bracket.

### BACKGROUND

The stringing of Christmas lights or other decorations along rooflines has become common in the United States. This activity requires climbing a ladder and manually attaching the decorations to either the gutter or the roof and can be dangerous, especially in the winter months or when it is conditions are damp. Ideally it would be safer if the person hanging the decorations could install a hanging bracket and the lights from the ground.

### SUMMARY

The disclosed system is a bracket that can be attached the lip of a gutter bracket or similar support member by sliding the bracket down upon the gutter lip using an extension pole having a male coupling at the distal end which engages a female coupling at the top of the gutter bracket. The bracket possesses a partially annular tubular hanger formed from the bottom of the proximal wall of the bracket by curling the bottom away from the gutter and back toward the gutter. The first and second ends of the partial annular receptacle are flared outward so as to curl the edges away from the strand and facilitate the movement of the decoration strand laterally through the partial annular tube.

The strand of decorations can be threaded through the annular receptacle prior to hanging. Upon hanging, the strand of decorations can be pulled tight laterally to minimize drooping of the strand. The flared ends of the partial annular tube

### BRIEF DESCRIPTION OF THE DRAWINGS

FIG. 1 depicts a side perspective view of a mountable hook.

FIG. 2 depicts a perspective view of a mountable hook with an embodiment of a female coupling and matched male coupling on an installation device.

FIG. 3 depicts depicts a perspective view of a mountable hook with an embodiment of a female coupling and matched male coupling on an installation device.

FIG. 4 depicts an embodiment of an installation device.

FIG. 5 depicts a telescoping pole with a threaded male coupling for mating with the installation device.

FIG. 6 depicts a telescoping pole coupled to an installation device preparing to engage a mountable hook for placement on a gutter lip.

### DETAILED DESCRIPTION OF THE PREFERRED EMBODIMENTS

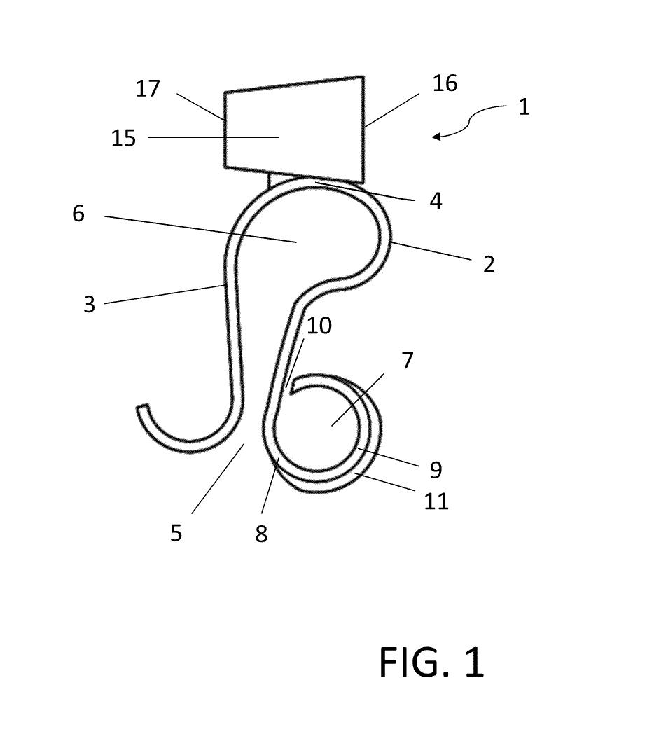

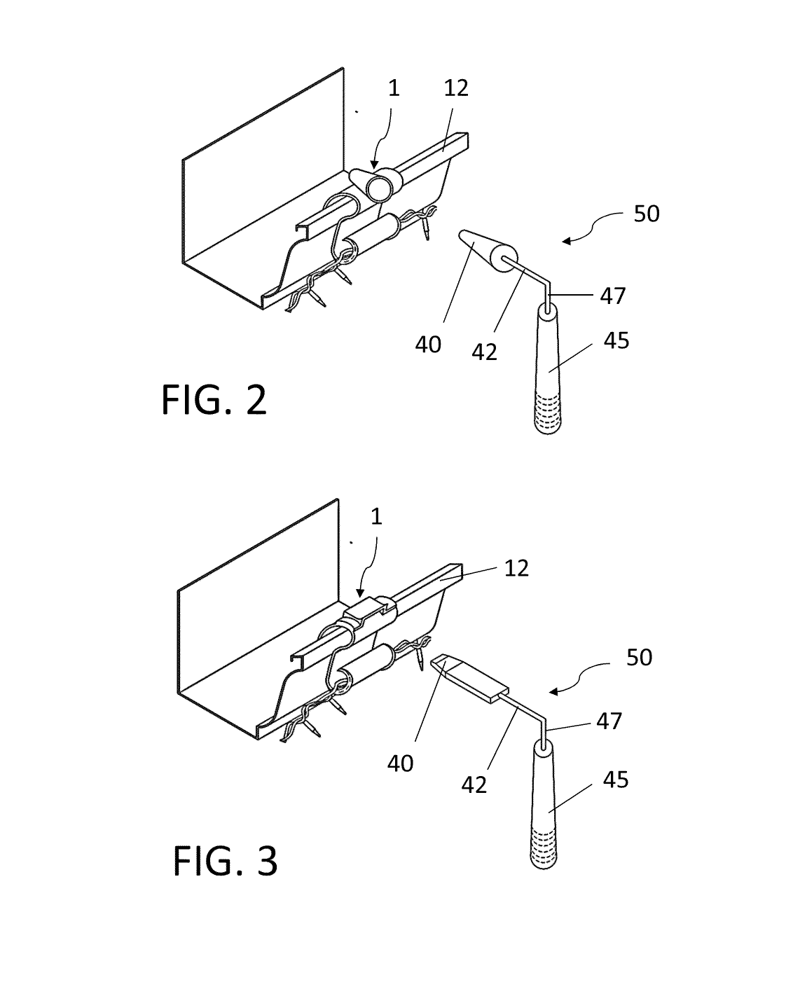

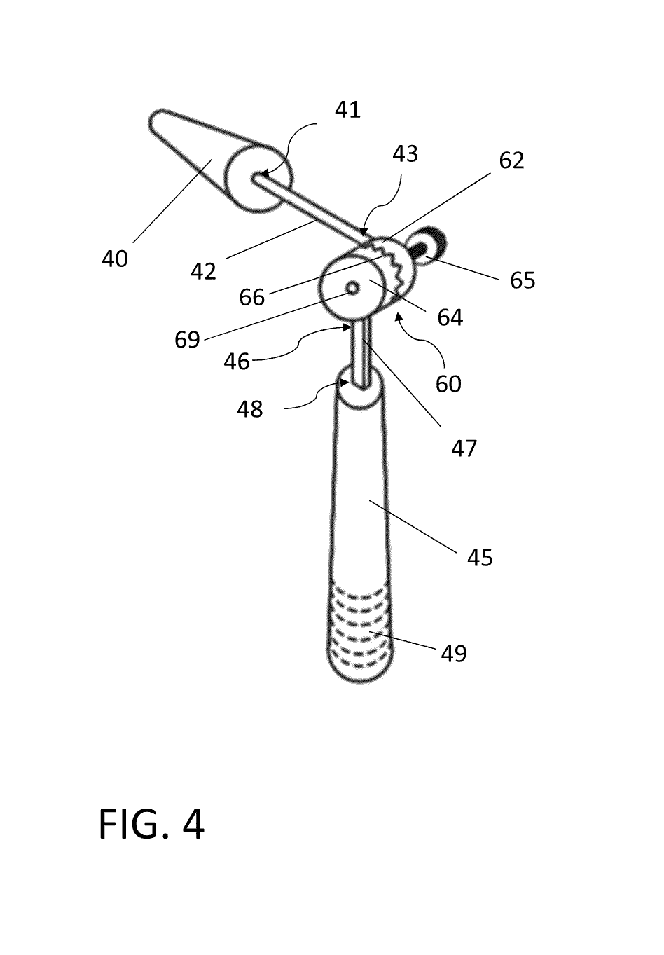

The mountable hook 1, as depicted in FIGS. 1 and 2, is, in appearance, generally a curved planar shape constructed from a semi-rigid material folded back upon itself along a first arcuate fold 4 so as to create a mounting clip portion oriented at the rear of the mountable hook and folded back upon itself at arcuate fold 8 to form a hook portion oriented at the front of the mountable hook. A first arcuate fold 4 comprises the mounting clip portion possesses a support retention channel 6 to at least partially enclose a support member 12 onto which the mountable hook is attached and a support passage channel 5 through which the support member 12 passes so as to be received into the support retention channel 6. Preferably the semi-rigid material from which the mountable hook 1 is constructed is flexible to the extent that the first arcuate fold 4 comprising the mounting clip portion permits the proximal wall 2 and distal wall 3 of the mounting clip portion to articulate apart from each other about the first arcuate fold 4 so as to permit the mountable hook 1 to slide over a support member 12 as it passes through the support passage channel 5. Once the support member 12 of greater diameter than the support passage channel 5 enters the support retention channel 6, the proximal wall 2 and distal wall 3 of the mountable hook 1 return to their original position due to the tension created along the point of rotation of the proximal wall 2 and distal wall 3 of the mountable hook 1 along the first arcuate fold 4.

The second arcuate fold 8 is made at the bottom of the proximal wall 2 of the mountable hook 1 and creates a “hook” or article retention channel 7 at the front of the mountable hook 1 by curling the semi-rigid material forward, up, and back toward the proximal wall 2 so as to form an article retention channel 7. In one preferred embodiment, the first arcuate fold 4 is shaped to allow retention of the lip of a common roof gutter. Further embodiments possess clamping areas of various sizes and geometries beneath the first arcuate fold 4 so as to facilitate the placement of the mountable hook 1 on tree limbs, tent supports, street lamps, and similar structures. Preferably, the article retention channel 7 acts to inhibit an article from inadvertently being removed by requiring the proximal hook wall 9 of the article retention channel 7 to be articulated away from the proximal wall 2 of the mounting clip so as to enlarge the retention channel passage 10.

The hook, as defined by 7, 8, 9, and 10 of the mountable hook 1 preferably possesses at least one outwardly flared end 11 to facilitate the passage of articles through the article retention channel 7. The flared end 11 facilitates the passage of articles such as strands of Christmas lights wherein the article is fashioned as a substantially smooth, rope-like structure bearing protruding attachments that could get caught on a non-flared edge if pulled through the article retention channel 7 and result in damage the retained article.

The flared end 11 of the hook is outwardly flared so as to create a smooth hook lip 11 which prevents the presentation of the otherwise blunt edges of the hook to the strand of lights, roped decorations, or wires so as to facilitate the movement of a strand laterally through the hook when pulled to minimize drooping between installed mountable hooks. The flaring of the hook is present across at least the bottom portion one end of the proximal hook wall 9.

A hollow, roughly conical female coupling 15 is affixed to the top of the first arcuate fold 4. The female coupling 15 is oriented to proximally present the female coupling entrance 16, which is preferably larger in cross-sectional area than the rest of said female coupling 15 and becomes progressively smaller along the length of the female coupling 15, reaching a point of smallest cross-sectional area or diameter at the female coupling end 17 so as to facilitate a snug friction fit arrangement.

The mountable hook 1 is placed onto a support member 12 such as a gutter lip or tree limb. The clip installation device 50 possesses a male coupling 40 at its distal end which is inserted laterally into the female coupling entrance 16 female coupling 15 of the mountable hook 1. The interior surface of the female coupling 15 and/or the surface of the male coupling 40 may optionally be coated with rubber or a similar material to increase friction between the male 40 and female 15 couplings so as to inhibit their unintentional decoupling. Ideally both the female 15 and male 40 couplings are conical in shape with the female coupling 15 being a hollow frustum of a cone and the male coupling being 40 a frustum of a cone so that the male coupling 40 mates with the female coupling 15 and is guided within by the progressively decreasing cross-sectional area created by the inner surface of the female coupling 15 when the female coupling 15 is oriented so as to present its largest cross-sectional area proximally. Alternatively, as shown in FIG. 3, other geometric shapes can be substituted for the male coupling 40 and female coupling 15. Additionally, the male 40 and/or female 15 couplings can be magnetic.

The proximal end of the clip installation device 50 possesses a means for coupling the device to an extension support 45 such as a common painter's pole. Ideally this would be an annular, threaded female painter's pole coupling 45 which would mate with the annular, threaded male painter's pole coupling of a commonly available painter's pole or telescoping extension pole. The male coupling 40 of the clip installation device 50 is preferably oriented at an obtuse angle to the male installation pole coupling 45 so as to facilitate its use at an obtuse angle when the user is situated on the ground and the target roof gutter is several feet above and in front of the user.

The clip installation device 50 is optionally comprised of an male coupling 40 joined to an installation arm 42 and a means for coupling the installation device to an extension support 45 joined to a support arm 47 so as to articulate about an installation arm-support arm joint 60. The installation arm 42 possesses a male coupling end 41 and a support arm 43 joint end. The support arm 47 possesses an installation arm joint end 46 which joins with the installation arm-support arm joint 60 and an extension support end 48 which joins with the means for coupling the installation device to an extension support 45.

The installation arm-support arm joint 60 is comprised of two opposing joint components, an installation arm joint component 62 and a support arm joint component 64. Each joint component 62, 64 has a joint surface 63 which mate along the joint surface interface 66. The installment arm 42 and support arm 47 are preferably joined across their joint surfaces 63 by a threaded fastener 65 across their mated joint surfaces 63. Also, each joint component 62, 64 has a fastener hole 69 through which the threaded fastener 65 passes. Preferably, one of the two fastener holes 69 is threaded to receive the threaded fastener 65.

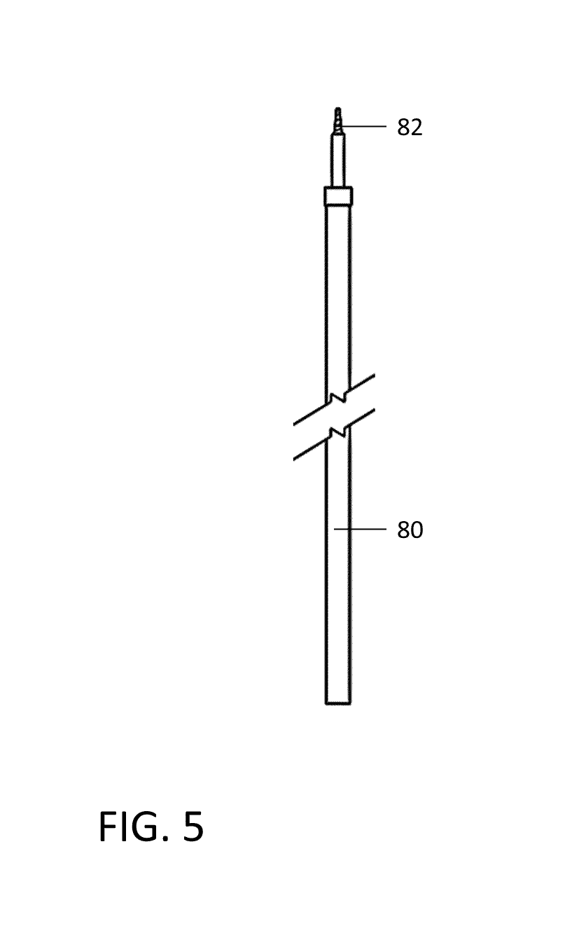

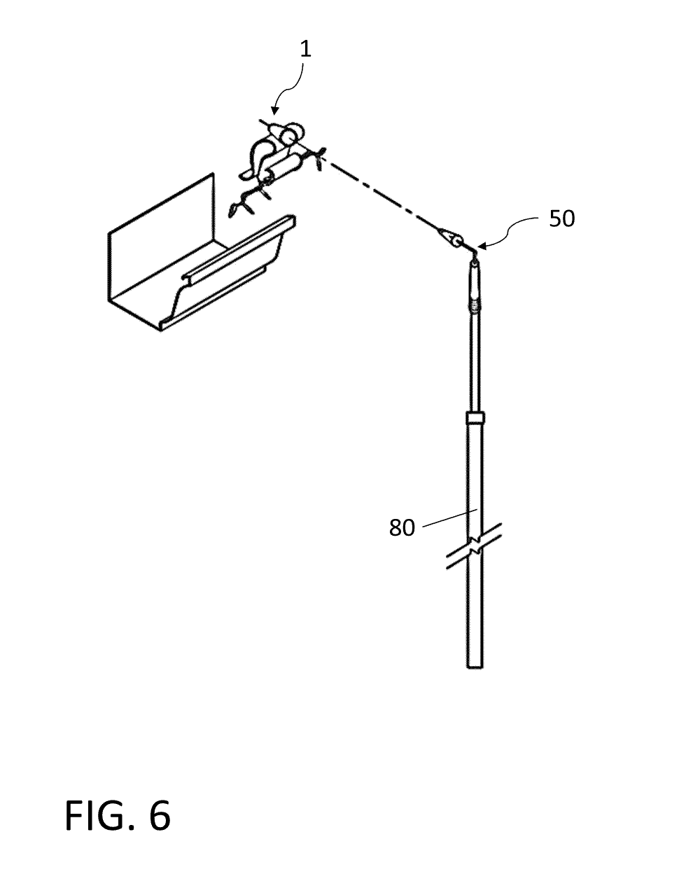

The joint 60 may be immobilized by tightening the fastener so as to inhibit articulation about the point of rotation once a desired angular relationship between the installation arm 42 and the support arm 47 is achieved. In a friction fit arrangement, the joint 60 need not be be tightened so as to completely prevent movement across the joint 60, but can be tightened sufficiently to stabilize the angular relationship between the installation arm 42 and the support arm 47 yet loose enough so as to move if sufficient pressure is applied to permit the user to adjust the joint 60 angle through pressure applied from the end of the installation pole 80, preferably a telescoping pole as depicted in FIGS. 5 and 6, coupled to the installation device 50, preferably by a threaded female coupling 49 designed to receive a threaded male coupling 82 such as on the distal end of a painter's pole 80. Additional embodiments may take advantage of other useful stops known in the art such as set screws and mated three dimensional topographies such as teeth. Further embodiments incorporate stops to limit articulation to a useful range of joint 60 angles.

What is claimed is:

1. A hanging support system comprising:
a. a mountable hook, said mountable hook having a mounting clip portion and a hook portion, said hook portion having flared ends; and
b. an installation coupling associated with said mountable hook, said installation coupling used for mating with an installation device coupling.

2. The system of claim 1, wherein said mountable hook is comprised of an elongated planar body.

3. The system of claim 2, wherein said mounting clip portion is formed from a first fold in said elongated planar body.

4. The system of claim 3, wherein said hook portion is formed from a second fold in said elongated planar body.

5. The system of claim 4, wherein said first fold and said second fold are arcuate.

6. The system of claim 1, wherein said installation coupling is affixed to said gutter clip atop said first fold.

7. The system of claim 1, wherein said coupling is magnetic.

8. The system of claim 1, wherein said coupling is selected from the group consisting of male and female couplings.

9. The system of claim 8, wherein said installation coupling is shaped as a hollow frustum of a geometric shape functioning as female coupling.

10. The system of claim 8, wherein said installation coupling is shaped as a frustum of a geometric shape functioning as male coupling.

11. The system of claim 8, further comprising a mountable hook installation device for installing said mountable hook by engaging said support clip with a support member.

12. The system of claim 11, wherein said mountable hook installation device comprises a mountable hook coupling which mates with said installation coupling on said mountable hook.

13. The system of claim 12, wherein said mountable hook installation device is coupled with an installation pole.

14. The system of claim 13, wherein said installation pole is a telescoping pole.

15. The system of claim 13, wherein said mountable hook installation device is comprised of an attachment installation arm and a support arm, said support arm possessing a coupling for joining said mountable hook installation device with said installation pole.

16. The system of claim 15 wherein said mountable hook installation device is further comprised of an articulating arm-support joint between said attachment installation arm and said support arm.

17. The system of claim 16, wherein said articulating arm-support joint is a friction fit arrangement between an attachment installation arm inner joint surface and a support arm inner joint surface.

18. The system of claim 16, wherein said articulating arm-support joint has a stop to inhibit articulation.

19. The system of claim 16, wherein said articulating arm-support joint articulates in response to a control means at said proximal end of said installation pole.

20. A hanging support system comprising:
a. a mountable hook formed from an elongated planar body wherein said mountable hook mounts onto a support member by a clip formed from a first arcuate fold in said elongated planar body and a hook is formed from an article retention channel created from a second arcuate fold in said elongated planar body, said hook portion having outwardly flared ends;
b. an installation coupling associated with said mountable hook, said installation coupling used for mating with an installation device coupling,
c. The system of claim 1, wherein said mountable hook is comprised of an elongated planar body.

21. The system of claim 20, further comprising a mountable hook installation device for installing said mountable hook by engaging said installation device with an installation coupling on said mountable hook so as to engage said clip with said support member.

22. The system of claim 11, wherein said mountable hook installation device comprises a mountable hook coupling which mates with said installation coupling on said mountable hook.

23. The system of claim 12, wherein said mountable hook installation device is coupled with an installation pole.

24. The system of claim 13, wherein said installation pole is a telescoping pole.
